(19) United States
(12) Patent Application Publication
(10) Pub. No.: US 2026/0220816 A1
(43) Pub. Date: Jul. 30, 2026

(54) DATA PROCESSING METHOD, APPARATUS, DEVICE, MEDIUM, AND PRODUCT

(71) Applicant: Beijing Zitiao Network Technology Co., Ltd., Beijing (CN)

(72) Inventors: Jiawei WEN, Beijing (CN); Hengkai GUO, Beijing (CN)

(21) Appl. No.: 19/458,430

(22) Filed: Jan. 23, 2026

(30) Foreign Application Priority Data
Jan. 24, 2025 (CN) 202510122618.3

(51) Int. Cl. G06T 7/73; G06T 7/246

(52) U.S. Cl. CPC G06T 7/74; G06T 7/248; G06T 2207/10016

(57) ABSTRACT

The present application discloses a data processing method, apparatus, device, medium and product, the method including: for any pair of adjacent images in a video, determining a position of a target plane in an image arranged behind based on multiple optical flow algorithms and a position of the target plane in an image arranged in front, thereby being able to automatically determine a change in the position of the target plane in the video in an iterative manner.

### CROSS-REFERENCE TO RELATED APPLICATIONS

The present application is based on and claims priority to Chinese Patent Application No. 202510122618.3, and filed on January 24, 2025, the entire disclosure of the Chinese Patent Application is hereby incorporated by reference in its entirety.

### TECHNICAL FIELD

The present disclosure relates to the field of data processing technology, and particularly to a data processing method, apparatus, device, medium, and product.

### BACKGROUND

Some scenarios, such as a video processing scenario or an augmented reality (AR) scenario, may have the following requirement: after a video is acquired, the content presented on a certain plane, for example, a large screen, common to respective frame images in the video shall be updated, for example, by adding certain content to the plane or replacing the content presented on the plane with other content, or the like. In addition, to meet this requirement, relevant personnel may manually determine the positions of the plane in respective frame images in the video, so that subsequent content updating can be performed based on the positions.

### SUMMARY

To solve the above technical problem, the present disclosure proposes a data processing method, apparatus, device, medium, and product, which can automatically determine or track a position change of a certain plane in a video, thereby reducing the cost.

To achieve the above object, the technical solutions provided in the present disclosure are as follows:

The present disclosure proposes a data processing method, the method including: acquiring a video, the video comprising a first image and a second image, an arrangement position of the first image in the video being adjacent to an arrangement position of the second image in the video, wherein the arrangement position of the first image in the video is ahead of the arrangement position of the second image in the video, wherein the first image and the second image both include a target plane; determining a position of the target plane in the second image based on multiple optical flow algorithms and a position of the target plane in the first image, wherein the multiple optical flow algorithms are used to determine motion information of the target plane between the first image and the second image, the motion information being used to describe a position change of the target plane when the target plane moves from the first image to the second image.

In a possible implementation, the multiple optical flow algorithms include a first algorithm and a second algorithm; wherein the target plane includes multiple tracking points; for any of the tracking points, a process of determining a position of the tracking point in the second image includes: determining a position prediction result of the tracking point under the second image based on the first algorithm, the second image, and a position of the tracking point in the first image; determining a tracking result of the first algorithm for the tracking point based on the position prediction result of the tracking point under the second image, the tracking result being used to indicate whether the tracking point can be tracked from the second image by using the first algorithm; in response to the tracking result indicating that the tracking point cannot be tracked from the second image by using the first algorithm, determining the position of the tracking point in the second image based on the second algorithm, the second image, and the position of the tracking point in the first image.

In a possible implementation, the position prediction result of the tracking point under the second image is used to indicate a position obtained by forward tracking the tracking point from the first image using the first algorithm; a process of determining the tracking result includes: determining a position prediction result of the tracking point under the first image based on the first algorithm, the first image, and the position prediction result of the tracking point under the second image, the position prediction result of the tracking point under the first image being used to indicate a position obtained by backward tracking the tracking point from the second image using the first algorithm; determining the tracking result based on a distance between the position prediction result of the tracking point under the first image and the position of the tracking point in the first image.

In a possible implementation, a process of determining the tracking result includes: determining a neighboring point corresponding to the tracking point in the first image based on the position of the tracking point in the first image, and determining a neighboring point corresponding to the tracking point in the second image based on the position prediction result of the tracking point under the second image; determining the tracking result based on a difference between the neighboring point corresponding to the tracking point in the first image and the neighboring point corresponding to the tracking point in the second image.

In a possible implementation, a process of determining the position of the target plane in the second image includes: determining first motion information based on the multiple optical flow algorithms, the second image and the position of the target plane in the first image, the first motion information being used to describe the position change of the target plane when the target plane moves from the first image to the second image; solving a homography between the first image and the second image based on the first motion information, the homography being used to describe a position mapping relationship of the target plane between the first image and the second image; determining the position of the target plane in the second image based on the homography and the position of the target plane in the first image.

In a possible implementation, if the first image is not a first frame image of the video, then a process of determining the homography includes: determining second motion information based on the multiple optical flow algorithms, the second image, and a position of the target plane in the first frame image, the second motion information being used to describe a position change of the target plane when the target plane moves from the first frame image to the second image; solving the homography between the first image and the second image based on the first motion information and the second motion information.

In a possible implementation, a process of determining the second motion information includes: acquiring a viewpoint of the first image; adjusting the first frame image based on the viewpoint of the first image to obtain an adjusted image, a viewpoint of the adjusted image being consistent with the viewpoint of the first image; determining the second motion information based on the multiple optical flow algorithms, the second image, and a position of the target plane in the adjusted image.

In a possible implementation, the viewpoint of the first image is determined based on the position of the target plane in the first image.

In a possible implementation, the method further includes: updating the video based on the position of the target plane in the first image and the position of the target plane in the second image, so that the content presented on the target plane described by the updated video is different from the content presented on the target plane described by the video before updating.

In a possible implementation, the target plane is determined based on a plane selection operation triggered for a first frame image of the video.

The present disclosure proposes a data processing apparatus, including: an acquisition unit configured to acquire a video, the video comprising a first image and a second image, an arrangement position of the first image in the video being adjacent to an arrangement position of the second image in the video, wherein the arrangement position of the first image in the video is ahead of the arrangement position of the second image in the video, wherein the first image and the second image both comprise a target plane; a determination unit configured to determine a position of the target plane in the second image based on multiple optical flow algorithms and a position of the target plane in the first image, wherein the multiple optical flow algorithms are used to determine motion information of the target plane between the first image and the second image, the motion information being used to describe a position change of the target plane when the target plane moves from the first image to the second image.

The present disclosure proposes an electronic device, including: a processor and a memory; wherein the memory is configured to store instructions or computer programs; wherein the processor is configured to execute the instructions or computer programs stored in the memory, so as to cause the electronic device to perform the data processing method proposed by the present disclosure.

The present disclosure proposes a computer-readable medium, wherein the computer-readable medium stores instructions or computer programs, which, when executed on a device, cause the device to perform the data processing method proposed by the present disclosure.

The present disclosure proposes a computer program product, comprising a computer program carried on a non-transitory computer-readable medium, the computer program comprising program codes for implementing the data processing method proposed by the present disclosure.

### BRIEF DESCRIPTION OF THE DRAWINGS

To make the technical solutions in embodiments of the present disclosure or in related technologies clearer, the following briefly introduces the accompanying drawings required for describing the embodiments or the related technologies, it is clear that the accompanying drawings in the following description show merely some embodiments describes in the present disclosure, and those ordinary skilled in the art may still derive other drawings from these accompanying drawings without paying creative efforts.

FIG. 1 is a schematic diagram of a data processing procedure according to an embodiment of the present disclosure;

FIG. 2 is a schematic diagram of content updating for a target plane according to an embodiment of the present disclosure;

FIG. 3 is a schematic diagram of another content updating for a target plane according to an embodiment of the present disclosure;

FIG. 4 is a structural schematic diagram of a data processing apparatus according to an embodiment of the present disclosure; and

FIG. 5 is a structural schematic diagram of an electronic device according to an embodiment of the present disclosure.

### DETAILED DESCRIPTION

It has been found through research that, in some relevant solutions, to meet the requirements described in the background section, relevant personnel may meet the requirements by manually adjusting the video frame-by-frame via a certain video editing tool. However, because such manual adjustment manner requires high-degree manual participation, the cost is relatively high.

It has also been found through research that, to better reduce the cost, an optical flow algorithm can be used to automatically determine a position change of a certain plane in the video, so as to achieve the purpose of plane tracking.

It has also been found through research that it is difficult for a single optical flow algorithm to simultaneously guarantee both tracking quantity and tracking quality. For example, a sparse optical flow (Bruce D. Lucas and Takeo Kanade, KLT) algorithm has a relatively high overall tracking accuracy but limited tracking quantity, which is likely to lead to a phenomenon of missing points during plane tracking. For another example, a dense optical flow algorithm or a deep optical flow algorithm has a relatively large tracking quantity, but its tracking accuracy is relatively lower than the tracking accuracy of the KLT algorithm.

Based on the above research, to better improve the effect of plane tracking, the present disclosure proposes a data processing method, which includes: first acquiring a video, the video comprising a first image and a second image, an arrangement position of the first image in the video being adjacent to an arrangement position of the second image in the video, wherein the arrangement position of the first image in the video is ahead of the arrangement position of the second image in the video, wherein the first image and the second image each includes a target plane; then determining a position of the target plane in the second image based on multiple optical flow algorithms and a position of the target plane in the first image, wherein the multiple optical flow algorithms are used to determine motion information of the target plane between the first image and the second image, the motion information being used to describe a position change of the target plane when the target plane moves from the first image to the second image.

It can be seen that, in the plane tracking solution shown above, for any pair of adjacent images in the video, a position of a target plane in an image arranged behind is determined based on multiple optical flow algorithms and a position of the target plane in an image arranged in front, thereby it is possible to automatically determine the position change of the target plane in the video in an iterative manner. Among them, because the multiple optical flow algorithms are used to determine motion information of the target plane between the adjacent images, the motion information can more accurately represent a position change of the target plane between the adjacent images, thereby making the position of the plane determined based on the motion information more accurate, which can effectively overcome defects caused by the fact that a single optical flow algorithm is difficult to simultaneously guarantee both tracking quantity and tracking quality, such as poor robustness and other defects, so that it is possible to implement stable and sufficient tracking of all tracking points in the target plane under the video, thereby being conducive to improving the tracking effect, for example, improving robustness of the tracking, or the like.

In addition, the present disclosure does not limit an execution subject of the data processing method, for example, the method can be applied to a terminal device or a server. For another example, the method can also be implemented through a data interaction process between the terminal device and the server. Among them, the terminal device can be a smart phone, a computer, a Personal Digital Assitant (PDA), a tablet computer, and the like. The server can be a stand-alone server, a cluster server, or a cloud server.

To enable those skilled in the art to better understand the technical solutions of the present disclosure, the following describes the technical solutions of embodiments of the present disclosure clearly and completely with reference to the accompanying drawings in the embodiments of the present disclosure. Obviously, the described embodiments are merely some, rather than all, of the embodiments of the present disclosure. All other embodiments obtained by those ordinary skilled in the art based on the embodiments of the present disclosure without paying creative efforts shall fall within the protection scope of the present application.

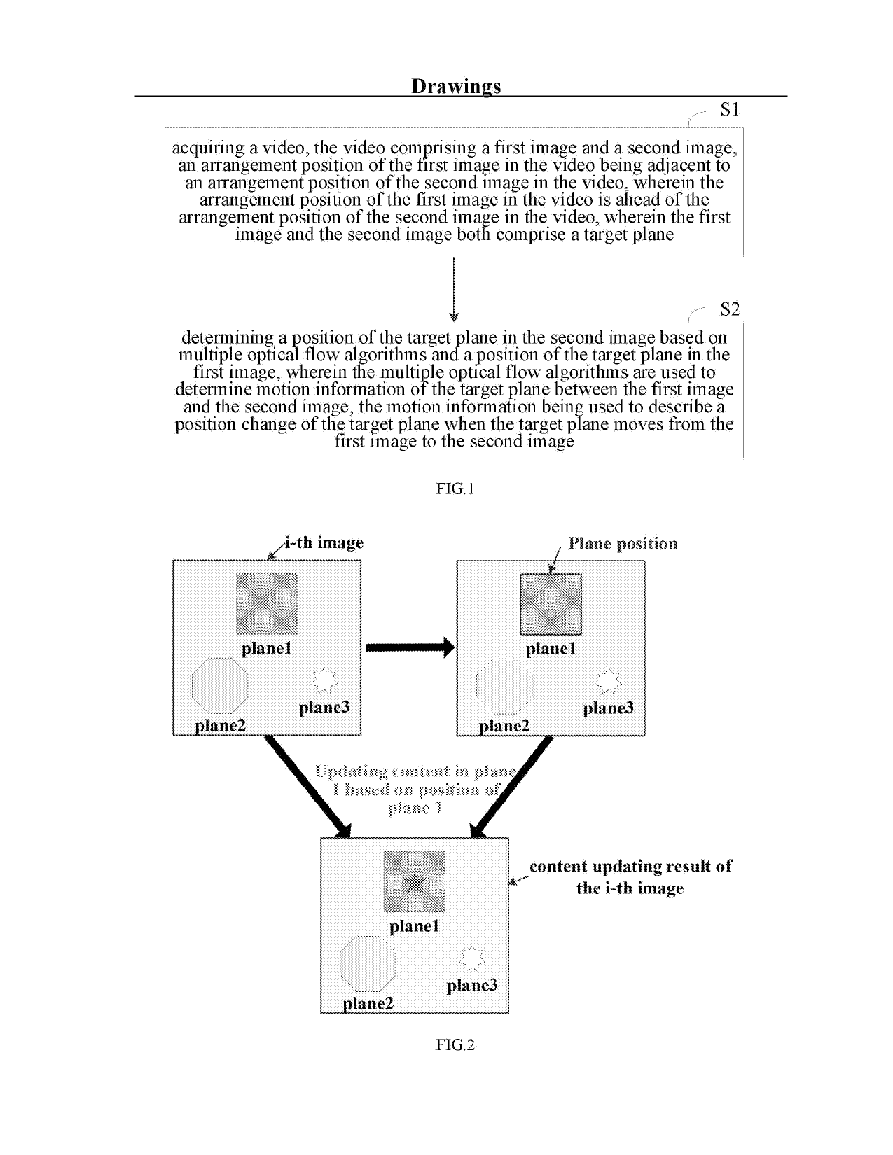

To better understand the technical solutions provided by the present disclosure, the data processing method provided by the present disclosure will be described below with reference to some accompanying drawings. As shown in FIG. 1, the data processing method provided in the embodiments of the present disclosure includes S1-S2 below.

S1: Acquire a video, the video comprising a first image and a second image, an arrangement position of the first image in the video being adjacent to an arrangement position of the second image in the video, wherein the arrangement position of the first image in the video is ahead of the arrangement position of the second image in the video, wherein the first image and the second image both comprise a target plane.

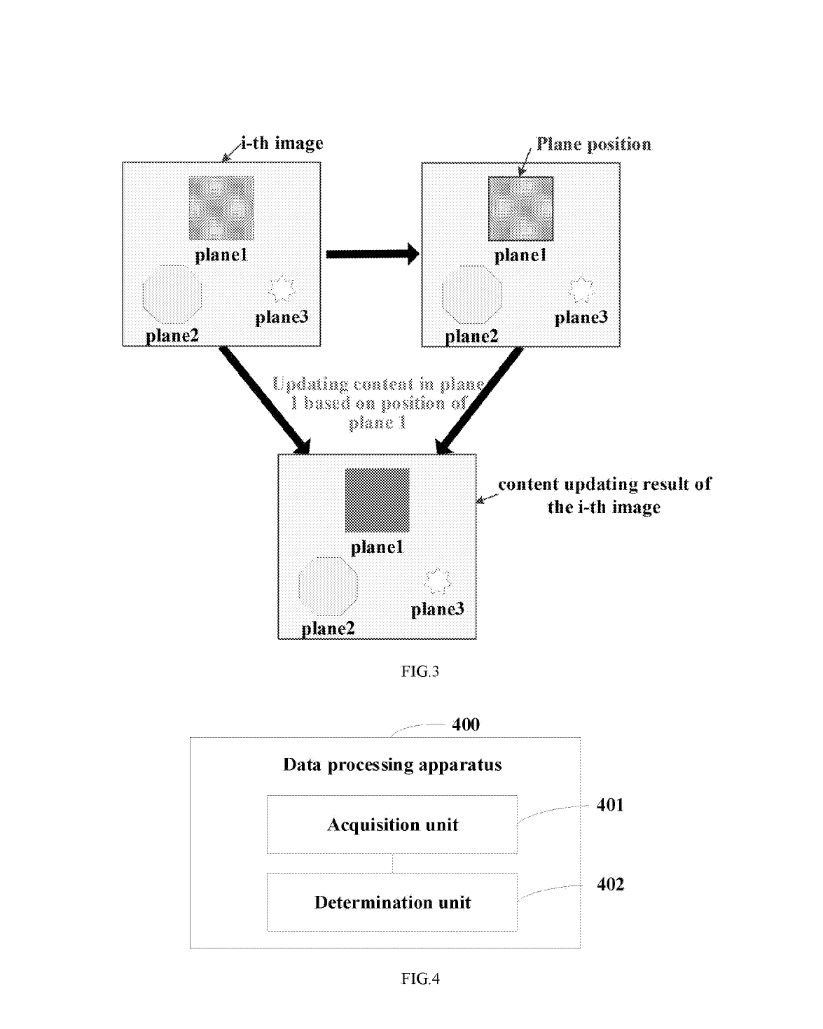

Among them, the first image refers to an image positioned relatively front in any pair of adjacent images existing in the video that needs plane tracking; and the second image refers to an image positioned relatively behind in the adjacent images. For example, if the first image is the i-th frame image in the video (such as the i-th frame image shown in FIG. 2 or FIG. 3), then the second image refers to the (i+1)-th frame image in the video, where i is a positive integer, and i+1≤the number of images in the video.

In addition, the present disclosure does not limit the acquisition manner of the above video, for example, any video acquisition manner, such as a video acquisition manner under an AR scenario, can be employed.

The target plane refers to a plane that needs position tracking and that is described by the above video, such as a large screen or a table top or the plane 1 shown in FIG. 2.

In addition, the present disclosure does not limit the relationship between the target plane and the video, for example, the relationship can be: the target plane exists in part or all of images in the video, so that such images can describe a change of the target plane (such as position change, shape change), thereby enabling the video to represent the change of the target plane. It should be noted that the present disclosure does not limit the cause of the change, for example, the change can be caused by the fact that the shooting state (such as shooting position, shooting angle) of a shooting device of the video continuously changes during shooting of the video. It should also be noted that, to better understand the plane tracking solution provided by the present disclosure, the following takes the case where each frame image of the video includes the target plane as an example for description.

In addition, in some scenarios, such as human-computer interaction scenarios, in order to better meet the plane tracking requirements of some users, the user can select a plane area as a target plane in a human-computer interaction manner, so that it is possible to meet the requirements in a manner of performing plane tracking with the target plane as a tracking target.

It can be seen that, in a possible implementation, the above target plane may be determined according to a plane selection operation triggered for a first frame image of the above video, so that it is possible to realize automatic fit tracking based on a plane area selected by the user through tracking processing for the target plane. The first frame image refers to an image existing in the video and located at a first arrangement position. The plane selection operation is used to indicate which plane area is selected by the user as a tracking target.

Based on the relevant content of the above S1, it can be known that, for some scenarios, such as AR scenarios, after obtaining a video on which the plane tracking needs to be performed, the user uses some tools to select a plane (such as the plane 1 shown in FIG. 2 or FIG. 3) that needs to be tracked for the video, so that it is possible to analyze out a position of the plane located in each frame image of the video through some optical flow algorithms, thereby realizing the plane tracking.

S2: Determine a position of the target plane in the second image based on multiple optical flow algorithms and a position of the target plane in the first image, wherein the multiple optical flow algorithms are used to determine motion information of the target plane between the first image and the second image, the motion information being used to describe a position change of the target plane when the target plane moves from the first image to the second image.

Among them, the multiple optical flow algorithms are used to determine motion information of the same plane (such as the plane 1 shown in FIG. 2 or FIG. 3) between two frame images, so that the motion information can present a position change of the plane between the two frame images, thereby enabling the motion information to present how the plane in one image changes so as to obtain the plane in another image.

In addition, the present disclosure does not limit the implementation of the above multiple optical flow algorithms, for example, the multiple optical flow algorithms may include a first algorithm (such as KLT algorithm) and a second algorithm (such as Deep optical flow algorithm), so that it is possible to determine motion information of the same plane between different images based on tracking results given by the two algorithms.

In addition, the present disclosure does not limit the relationship between the first algorithm and the second algorithm, for example, the two algorithms may at least satisfy the following constraints: the tracking accuracy of the first algorithm is higher than the tracking accuracy of the second algorithm, but the tracking quantity of the first algorithm is less than the tracking quantity of the second algorithm, so that it is possible to determine certain tracking point information in the plane tracking mainly by the first algorithm, and supplement remaining tracking point information in areas where the first algorithm cannot track by using the second algorithm as an auxiliary. Among them, the tracking accuracy is used to indicate whether a position of a tracking point that can be predicted using a certain optical flow algorithm is accurate. The tracking quantity is used to indicate the number of tracking points that can be predicted using a certain optical flow algorithm.

It can be seen that, in a possible implementation, the above first algorithm may be a KLT algorithm, and the second algorithm may be a dense optical flow algorithm or a Deep optical flow algorithm. Because the KLT algorithm has the highest overall accuracy but limited tracking quantity, it is possible to make a supplement with the Deep optical flow algorithm (or the dense optical flow algorithm) in areas where KLT algorithm cannot track, so that the solution realized by using KLT algorithm and Deep optical flow algorithm (or dense optical flow algorithm) can stably and sufficiently track tracking points within a certain plane, thereby realizing a robust tracking solution.

In addition, the present disclosure does not limit the implementation of the above S2. For example, it may be specifically as follows: firstly, use multiple optical flow algorithms to determine information about motion of the target plane between the first image and the second image, so that the motion information can indicate a change (such as position change, shape change, etc.) occurring between a state of the target plane in the first image and a state of the target plane in the second image, thereby enable the motion information to indicate how to change the target plane in the first image to obtain the target plane in the second image; then, determine the position of the target plane in the second image based on the motion information and the position of the target plane in the first image.

It should be noted that the present disclosure does not limit the acquisition manner of the above " position of the target plane in the first image". For example, for the first image (such as the i-th frame image in the video), if the first image is the first frame image of the video (such as i=1), then it is possible to determine the position of the target plane in the first image according to a plane selection operation triggered by a user for the first frame image, so that the target plane can indicate a plane that is selected by the user and needs to be tracked; however, if the first image is not the first frame image of the video (such as i≥2), then it is possible to determine that the video further includes a previous frame image corresponding to the first image (such as the (i-1)-th frame image), therefore, it is possible to firstly use multiple optical flow algorithms to determine motion information of the target plane between the previous frame image and the first image, so that the motion information can indicate a position change of the target plane occurring when the target plane moves from the previous frame image to the first image; then, determine the position of the target plane in the first image based on the motion information and the position of the target plane in the previous frame image. Among them, the arrangement position of the previous frame image in the video is adjacent to the arrangement position of the first image in the video, and the arrangement position of the previous frame image in the video is ahead of the arrangement position of the first image in the video.

It should also be noted that the present disclosure does not limit the implementation of the above " motion information of the target plane between the first image and the second image", for example, when the target plane includes multiple tracking points, the "motion information of the target plane between the first image and the second image" may include motion information of each tracking point between the first image and the second image, such as position offsets in various directions (such as offsets in UV coordinates) and other information. Among them, a tracking point refers to a pixel point existing in the target plane and having a tracking value. In addition, the present disclosure does not limit the implementation of these tracking points, for example, they may include part or all of the pixel points in the target plane.

It should also be noted that the present disclosure does not limit the implementation of the above step of "determining the position of the target plane in the second image based on the motion information and the position of the target plane in the first image", for example, it can adopt any method capable of solving the position of the next frame based on the motion information, the position of the previous frame, such as by using a machine learning model that is constructed in advance and has a position solving function.

It should also be noted that the present disclosure does not limit the implementation of the above step of "determining motion information of the target plane between the first image and the second image by using multiple optical flow algorithms", for example, it can be: first using each algorithm to process the first image and the second image to obtain processing results corresponding to each algorithm, so that these processing results can respectively indicate the tracking point information obtained by using each algorithm; then integrating these processing results (such as calculating an average value thereof) to obtain the motion information of the target plane between the first image and the second image.

Based on the above contents related to S1 to S2, it is known that, in the plane tracking solution proposed in the present disclosure, for any pair of adjacent images in the video, a position of a target plane in an image arranged behind is determined based on multiple optical flow algorithms and a position of the target plane in an image arranged in front, thereby it is possible to automatically determine the position change of the target plane in the video in an iterative manner. Among them, because the multiple optical flow algorithms are used to determine motion information of the target plane between the adjacent images, the motion information can more accurately represent a position change of the target plane between the adjacent images, thereby making the position of the plane determined based on the motion information more accurate, which can effectively overcome defects caused by the fact that a single optical flow algorithm is difficult to simultaneously guarantee both tracking quantity and tracking quality, such as poor robustness and other defects, so that it is possible to implement stable and sufficient tracking of all tracking points in the target plane under the video, thereby being conducive to improving the tracking effect, for example, improving robustness of the tracking, or the like.

In addition, in order to better improve the tracking effect, the present disclosure also proposes a possible implementation of the above S2, in which when the above multiple optical flow algorithms include a first algorithm and a second algorithm, and the target plane includes N tracking points, N is a positive integer, the position of the target plane in the second image may include the position of each tracking point in the second image, and S2 may include some or all of the following steps 11 to 14.

Step 11: determining a position prediction result of the j-th tracking point under the second image based on the first algorithm (such as KLT algorithm), the second image, and the position of the j-th tracking point in the first image, so that the position prediction result is used to indicate a position obtained by forward tracking the j-th tracking point from the first image using the first algorithm, j is a positive integer, j≤N. It should also be noted that the forward tracking refers to performing plane tracking in a direction of timeline change of the above video, so that the direction of the plane tracking is the same as the direction of the timeline change.

Among them, the position prediction result of the j-th tracking point under the second image refers to a position that is tracked by using the first algorithm and is determined by tracking the j-th tracking point from the first image to the second image, so that the position prediction result can be used to describe the predicted position of the j-th tracking point under the second image.

In addition, the present application does not limit the implementation of the above step 11, for example, it can be: first using the first algorithm to determine the motion information of the j-th tracking point between the first image and the second image, so that the motion information can indicate a position change that is predicted to occur when moving from a position where the j-th tracking point is located in the first image to a position where the j-th tracking point is located in the second image, thereby enabling the motion information to indicate what kind of position change is predicted to be performed on the j-th tracking point in the first image to obtain the j-th tracking point in the second image; then determining a position prediction result of the j-th tracking point under the second image based on the motion information and the position of the j-th tracking point in the first image, so that the position prediction result can indicate the information that is determined by using the first algorithm for the j-th tracking point and describes the predicted position of the j-th tracking point in the second image.

Step 12: determining a tracking result of the first algorithm under the j-th tracking point based on the position prediction result of the j-th tracking point under the second image, where the tracking result is used to indicate whether the j-th tracking point can be tracked from the second image by using the first algorithm, j is a positive integer, j≤N.

Among them, the tracking result of the first algorithm under the j-th tracking point is used to describe the tracking performance presented by the first algorithm under the j-th tracking point, so that the tracking result can indicate whether the j-th tracking point can be precisely tracked from the second image by using the first algorithm, thereby enabling the tracking result to indicate whether the first algorithm can implement successful tracking for the j-th tracking point.

In addition, the present disclosure does not limit the implementation of the above step 12, for example, it can adopt any method capable of evaluating the tracking performance presented by a certain optical flow algorithm for each tracking point, for example, a method realized by a machine learning model having a tracking performance evaluation function.

It has been found through research that, in some scenarios, the tracking quality of an optical flow algorithm can be detected by using the same optical flow algorithm to perform forward tracking inference and backward tracking inference.

Based on the above research, it is known that, in order to better improve the tracking effect, the above step 12 may include the following steps 121 to 122.

Step 121: Based on the first algorithm, the first image, and the position prediction result of the j-th tracking point under the second image, determine the position prediction result of the j-th tracking point under the first image, so that the position prediction result is used to indicate the position obtained by backward tracking of the tracking point from the second image using the first algorithm. It should be noted that the backward tracking refers to performing plane tracking in a direction reverse to the above-described timeline change direction of the video, so that the direction of the plane tracking is opposite to the timeline change direction.

Among them, the position prediction result of the j-th tracking point under the first image refers to a result which is obtained by the first algorithm through backward tracking with the forward tracking result as a starting point after the first algorithm derives the position of the j-th tracking point in the second image through the forward tracking, and which is used to describe the predicted position of the j-th tracking point in the first image.

In addition, the present disclosure does not limit the implementation of step 121, for example, it may be similar to the implementation of the above step 11.

Step 122: Based on a distance between the position prediction result of the j-th tracking point under the first image and the position of the j-th tracking point in the first image, determine the tracking result of the first algorithm for the j-th tracking point.

In the present disclosure, after deriving the position prediction result of the j-th tracking point under the first image by the first algorithm in the backward tracking manner, the distance between the position prediction result and the position of the j-th tracking point in the first image is calculated first, so that the distance can represent the tracking accuracy presented by the first algorithm for the j-th tracking point to some extent, the smaller the distance is, the higher the tracking accuracy is; then it is judged whether the distance exceeds a preset first threshold, if exceeds, it can be determined that the tracking accuracy presented by the first algorithm for the j-th tracking point is relatively poor, therefore, preset first data (such as a string "tracking failed") can be determined as the tracking result of the first algorithm for the j-th tracking point, so that the tracking result can indicate that the j-th tracking point cannot be tracked from the second image by using the first algorithm; if not exceed, it can be determined that the tracking accuracy presented by the first algorithm for the j-th tracking point is relative good, therefore, preset second data (such as a string "tracking succeeded") can be determined as the tracking result of the first algorithm for the j-th tracking point, so that the tracking result can indicate that the j-th tracking point is tracked from the second image by using the first algorithm.

Based on the relevant content of the above steps 121 to 122, it can be known that in some scenarios, the same optical flow algorithm (such as the KLT algorithm) can be used for forward inference of tracking point information between two frames of images and backward inference of the tracking point information between two frames of images, so as to detect whether the optical flow algorithm can accurately predict the motion information of a certain tracking point between the two frames of images, to obtain the tracking result of the optical flow algorithm for the tracking point.

It has been found through research that the luminance presented by the same tracking point in different images hardly changes, so that a luminance difference presented by the tracking point between different images is relatively small, therefore, the luminance difference can be used to detect the tracking effect of a certain optical flow algorithm for the tracking point.

It has also been found through research that for a certain tracking point, the luminance presented by the tracking point in an image can be determined via pixels (referred to as neighboring points below) in the image that are close to the tracking point.

Based on the above research, in order to better improve the tracking effect, the above step 12 may include the following steps 123-124.

Step 123: determine a neighboring point corresponding to the j-th tracking point in the first image based on a position of the j-th tracking point in the first image, and determine a neighboring point corresponding to the j-th tracking point in the second image based on the position prediction result of the j-th tracking point under the second image.

Among them, the neighboring point corresponding to the j-th tracking point in the first image refers to a pixel that exists in the first image and is close to the j-th tracking point, such as a pixel in a small patch area in the first image centered on the j-th tracking point.

It can be seen that the neighboring point corresponding to the j-th tracking point in the first image can at least satisfy the following constraints: the first image includes the neighboring point, and a distance between the position of the neighboring point located in the first image and the position of the j-th tracking point located in the first image (that is, the above "position of the j-th tracking point in the first image") is less than a preset second threshold. Among them, the second threshold can be determined according to actual application scenarios.

The neighboring point corresponding to the j-th tracking point in the second image refers to a pixel that exists in the second image and is close to the j-th tracking point, such as a pixel in a small patch area in the second image centered on the j-th tracking point.

It can be seen that the neighboring point corresponding to the j-th tracking point in the second image can at least satisfy the following constraints: the second image includes the neighboring point, and a distance between the position of the neighboring point located in the second image and the position of the j-th tracking point located in the second image (that is, the position described by the above "the position prediction result of the j-th tracking point under the second image") is less than the preset second threshold.

Step 124: determine the tracking result of the first algorithm for the j-th tracking point based on a difference between the neighboring point corresponding to the j-th tracking point in the first image and the neighboring point corresponding to the j-th tracking point in the second image.

It should be noted that the present disclosure does not limit the implementation of the above step 124. For example, it can specifically be: firstly, calculate the luminance (such as SSD score) presented by the j-th tracking point in the first image based on neighboring points corresponding to the j-th tracking point in the first image, and calculate the luminance (such as SSD score) presented by the j-th tracking point in the second image based on neighboring points corresponding to the j-th tracking point in the second image; then, calculate a difference between the luminance presented by the j-th tracking point in the second image and the luminance presented by the j-th tracking point in the first image, as a luminance difference, so that the luminance difference can indicate the difference between the neighboring points corresponding to the j-th tracking point in the first image and the neighboring points corresponding to the j-th tracking point in the second image to some extent; finally, determine the tracking result of the first algorithm for the j-th tracking point based on the luminance difference.

It can be seen that in the present disclosure, after acquiring the difference between the neighboring points corresponding to the j-th tracking point in the first image and the neighboring points corresponding to the j-th tracking point in the second image (such as the above luminance difference), it is judged whether the difference exceeds a preset third threshold. If exceeds, it can be determined that the tracking accuracy presented by the first algorithm for the j-th tracking point is relatively poor, so the above first data (such as the string "tracking failed") can be determined as the tracking result of the first algorithm for the j-th tracking point; if not exceed, it can be determined that the tracking accuracy presented by the first algorithm for the j-th tracking point is relatively good, so the above second data (such as the string "tracking succeeded") can be determined as the tracking result of the first algorithm for the j-th tracking point.

Based on the relevant contents of the above steps 123 to 124, it can be known that in some scenarios, it can be determined whether the optical flow algorithm can accurately predict the motion information of a certain tracking point between the two frames of images by calculating the luminance difference between the same tracking point in different images, so as to obtain the tracking result of the optical flow algorithm for the tracking point.

In addition, in order to better improve the effect, the inference manner shown by the above steps 121 to 122 and the inference manner shown by the above steps 123 to 124 can be used together to determine the tracking result of the optical flow algorithm for the tracking point. Based on this, it can be known that in a possible implementation, the above step 12 can specifically be:

Firstly, determine the position prediction result of the j-th tracking point under the first image based on the first algorithm, the first image, and the position prediction result of the j-th tracking point under the second image, determine the neighboring points corresponding to the j-th tracking point in the first image based on the position of the j-th tracking point in the first image, and determine the neighboring points corresponding to the j-th tracking point in the second image based on the position prediction result of the j-th tracking point under the second image; then, determine the tracking result of the first algorithm for the j-th tracking point based on the distance between the position prediction result of the j-th tracking point under the first image and the position of the j-th tracking point in the first image, and the difference between the neighboring points corresponding to the j-th tracking point in the first image and the neighboring points corresponding to the j-th tracking point in the second image.

It can be seen that in the present application, after acquiring the distance between the position prediction result of the j-th tracking point under the first image and the position of the j-th tracking point in the first image, and the difference between the neighboring points corresponding to the j-th tracking point in the first image and the neighboring points corresponding to the j-th tracking point in the second image, if the distance does not exceed the first threshold value and the difference does not exceed the third threshold value, it can be determined that the tracking accuracy presented by the first algorithm for the j-th tracking point is relatively good, so the above second data (such as the string "tracking succeeded") can be determined as the tracking result of the first algorithm for the j-th tracking point; conversely, it can be determined that the tracking accuracy presented by the first algorithm for the j-th tracking point is relatively poor, so the above first data (such as the string "tracking failed") can be determined as the tracking result of the first algorithm for the j-th tracking point.

Based on the related contents of the above step 12, it can be known that after the position prediction result of the j-th tracking point under the second image is obtained by performing forward tracking from the first image by using the first algorithm, the tracking result of the first algorithm under the j-th tracking point can be determined based on the position prediction result, so that the tracking result can indicate whether the j-th tracking point can be accurately tracked from the second image by using the first algorithm.

Step 13: In response to the above tracking result indicating that the j-th tracking point cannot be tracked from the second image by using the first algorithm, determine the position of the j-th tracking point in the second image based on the second algorithm (such as the Deep optical flow algorithm), the second image, and the position of the j-th tracking point in the first image, where j is a positive integer and j ≤ N.

In the present disclosure, after acquiring the tracking result of the first algorithm for the j-th tracking point, if the tracking result is used to indicate that the j-th tracking point cannot be tracked from the second image by using the first algorithm, it can be determined that the position prediction result of the j-th tracking point under the second image determined by using the first algorithm is not accurate, so other optical flow algorithms (such as Deep optical flow algorithm) can be used for supplementary inference of the position of the j-th tracking point in the second image.

It should be noted that the present disclosure does not limit the implementation of the above step 13, for example, it can specifically be: first determine motion information of the j-th tracking point between the first image and the second image by using the second algorithm; then determine a position of the j-th tracking point in the second image based on the motion information and a position of the j-th tracking point in the first image.

Step 14: In response to the above tracking result indicating that the j-th tracking point is tracked from the second image by using the first algorithm, determine a position prediction result of the j-th tracking point under the second image as a position of the j-th tracking point in the second image, wherein j is a positive integer, and j≤N.

In the present disclosure, after acquiring a tracking result of the first algorithm for the j-th tracking point, if the tracking result is used to indicate that the j-th tracking point can be accurately tracked from the second image by using the first algorithm, it can be determined that the position prediction result of the j-th tracking point under the second image determined by the first algorithm is relatively accurate, so the position prediction result can be directly used as the position of the j-th tracking point in the second image.

Based on the relevant contents of the above steps 11 to 14, it can be known that the present disclosure can perform the plane tracking by using multiple optical flow algorithms in combination, so as to obtain positions of all tracking points within the same plane in each frame image of the video, thereby achieving stable and sufficient tracking effect.

It has been found through research that, for the motion information of the target plane between the first image and the second image derived by means of multiple optical flow algorithms, because the number of tracking points within the target plane is relatively large, which makes the data volume of the motion information relatively large, the plane position solving based on the motion information would be relatively complex, which in turn makes the cost of the solving process relatively large. In addition, because there may be errors in the motion information predicted for a single tracking point, which makes there are many errors when performing the plane position solving based on the motion information of such tracking points, the accuracy of the final solving result is slightly worse.

Based on the above research, in order to better solve the problem shown in the above paragraph, the present disclosure also proposes a possible implementation of the above S2, in which the S2 can include the following steps 21-23.

Step 21: Determine first motion information based on multiple optical flow algorithms, the second image, and a position of the target plane in the first image, so that the first motion information is motion information of the target plane between the first image and the second image, and can describe a position change of the target plane occurring when the target plane moves from the first image to the second image.

It should be noted that the present disclosure does not limit the implementation of the first motion information, for example, when the target plane includes multiple tracking points, the first motion information can include motion information of each tracking point between the first image and the second image. Among them, the motion information of the j-th tracking point between the first image and the second image is used to describe the position change of the j-th tracking point occurring when the j-th tracking point moves from the first image to the second image, wherein j is a positive integer, and j≤N.

It also should be noted that the implementation of the above step 21 can refer to the above relevant content.

Step 22: Solve a homography between the first image and the second image based on the first motion information, wherein the homography is used to describe a position mapping relationship of the target plane between the first image and the second image.

Among them, the homography is used to describe a relationship between pixel positions in different images corresponding to a point in the real world, such as a transformation relationship, etc., so that the homography can describe a position transformation relationship of the same point (such as each tracking point) between two frames of images.

In addition, the present disclosure does not limit the implementation of the above step 22, for example, it can adopt any method capable of solving the homography based on motion information of multiple points, for example, by using some pre-set derivation formulas or a pre-constructed machine learning model having a homography solving function.

Step 23: Determine a position of the target plane in the second image based on the above homography and the position of the target plane in the first image.

It should be noted that the present disclosure does not limit the implementation of step 23.

Based on the relevant contents of the above steps 21 to 23, it can be known that after inferring motion information of each tracking point within the target plane between the first image and the second image by using multiple optical flow algorithms, a homography with a smaller data volume and higher accuracy can be solved first based on such motion information, and then a position of the target plane in the second image can be calculated based on the homography. Among them, because the data volume of the homography is much smaller than the data volume of these motion information, the defect caused by the fact that the data volume of such motion information is relatively large can be overcome; also because the homography is obtained by fitting motion information of multiple tracking points, which makes the position change described by the homography more accurate, the plane tracking realized based on the homography can be more accurate, which is conducive to improving the plane tracking effect.

It has been found through research that, when performing plane tracking on a video, for any pair of adjacent images in the video, a position of the plane in an image arranged behind can be obtained by inference based on a position of the plane in an image arranged in front, so that the plane tracking of the video is obtained by iteratively inferring the plane position, thereby when the plane position inference is performed for an image arranged relatively behind in the video, a tracking area offset phenomenon may occur due to accumulation of many errors, which affects the tracking effect.

Based on the above research, in order to better improve the tracking effect, the present disclosure also proposes a possible implementation of the above step 22. In this implementation, when the first image is not the first frame image of the video, the step 22 may include the following steps 221-222.

Step 221: Determine second motion information based on multiple optical flow algorithms, the second image, and the position of the target plane in the above first frame image, so that the second motion information is motion information of the target plane between the first frame image and the second image, thereby causing the second motion information to be used for describing the position change of the target plane occurring when the target plane moves from the first frame image to the second image.

It should be noted that the present disclosure does not limit the implementation of the second motion information, for example, when the target plane includes multiple tracking points, the second motion information may include motion information of each tracking point between the first frame image and the second image. Among them, the motion information of the j-th tracking point between the first frame image and the second image is used for describing the position change of the j-th tracking point occurring when the j-th tracking point moves from the first frame image to the second image, where j is a positive integer, j≤N.

It should also be noted that the above process of determining the second motion information is similar to the above process of determining the first motion information, for brevity, it will not be described again here.

Step 222: Solve the homography between the first image and the second image based on the first motion information and the second motion information.

It should be noted that the present disclosure does not limit the implementation of the above step 222, for example, it may specifically be: firstly, perform a homography solving process based on the first motion information to obtain a first matrix, so that the first matrix can describe a position mapping relationship of the target plane between the first image and the second image, and perform a homography solving process based on the second motion information to obtain a second matrix, so that the second matrix can describe a position mapping relationship of the target plane between the first image and the second image; then integrate (such as weighted sum) the first matrix and the second matrix to obtain the homography between the first image and the second image.

It should be noted that the present disclosure does not limit the above process of solving the second matrix. For example, it may specifically be: firstly, perform the homography solving processing based on the second motion information to obtain a homography between the first frame image and the second image, so that the homography can describe a position mapping relationship of the target plane between the first frame image and the second image; then obtain the second matrix based on a difference between the homography between the first frame image and the second image and the homography between the first frame image and the first image, so that the second matrix can describe a position mapping relationship of the target plane between the first image and the second image. Among them, the "homography between the first frame image and the first image" is used for describing the position mapping relationship of the target plane between the first frame image and the first image; and the present disclosure does not limit the manner of acquiring the "homography between the first frame image and the first image", for example, the "homography between the first frame image and the first image" may be acquired during the plane tracking process for the first image. Alternatively, the "homography between the first frame image and the first image" may be acquired through performing the homography solving process for the motion information of the target plane between the first frame image and the first image, and the process of determining the "motion information of the target plane between the first frame image and the first image" is similar to the above process of determining the first motion information, for brevity, it will not be described again here.

Alternatively, the above step 222 may specifically be: perform the homography solving based on a set between the first motion information and the second motion information to obtain the homography between the first image and the second image.

Based on the relevant content of the above steps 221 to 222, it can be known that, in some scenarios, in order to solve a problem of tracking area offset occurring after long-term tracking, the homography between the first image and the second image may be solved based on the position of the target plane in the first frame image of the video and the motion information of the target plane between the first image and the second image, so that the homography can satisfy characteristics of the target plane described by the first frame image of the video, such as a relationship between different tracking points within the target plane or the like, thereby making it possible to correct the offset as much as possible with the help of the first frame image, so that the tracking effect can be effectively improved.

It has been found through research that, for two frames of images in the video that are relatively far apart, due to a large difference between shooting states (such as shooting angles) of these two frames of images, these two frames of images present a large difference under some dimensions (such as shooting angle and other dimensions), which easily affects the solving effect of the homography.

Based on the above research, in order to better improve the effect, the present disclosure also proposes a process of determining the above second motion information, which may specifically include the following steps 31 to 33.

Step 31: Acquire a viewpoint of the first image, so that the viewpoint is used for describing an angle at which the target plane is presented in the first image.

It should be noted that the present disclosure does not limit the acquisition manner of the above viewpoint of the first image, for example, it may adopt any method capable of acquiring a viewpoint of an image, for example, a method of directly reading a shooting angle from a shooting device of the image.

In addition, in order to further improve accuracy, the viewpoint of the above first image may be determined based on the position of the target plane in the first image, so that the viewpoint can more accurately describe an angle at which the target plane is presented in the first image. It should be noted that the present disclosure does not limit the implementation of the determination. For example, it may adopt any method capable of inferring a shooting angle of a plane based on a position of the plane, such as by using a pre-constructed machine learning model having a shooting angle prediction function or by using some preset inference formulas.

Step 32: Adjust the above first frame image based on the viewpoint of the first image to obtain an adjusted image, so that the viewpoint of the adjusted image remains consistent with the viewpoint of the first image.

It should be noted that the present disclosure does not limit the implementation of "remain consistent", for example, it may refer to being identical or highly similar (for example, the similarity is greater than a preset similarity threshold).

It should also be noted that the present disclosure does not limit the implementation of the above step 32, for example, it may adopt any method capable of adjusting an image according to a certain viewpoint, such as by using a machine learning model having an image adjustment function constructed in advance, or by using some preset inference formulas, or by using any method used to implement image warping.

It can be seen that, in a possible implementation, the above step 32 specifically can be: firstly determine a transformation matrix based on a difference between the viewpoint of the first image and the viewpoint of the above first frame image, so that the transformation matrix can describe a relationship between an image presented under the viewpoint of the first image and an image presented under the viewpoint of the first frame image, such as a transformation relationship between pixel point positions; then adjust the first frame image according to the transformation matrix to obtain an adjusted image, so that the viewpoint of the adjusted image remains consistent with the viewpoint of the first image, thereby making the viewpoint of the adjusted image as close as possible to the viewpoint of the second image, therefore, the defect that too large viewpoint difference between two frames of images would result in poor homography solving effect can be effectively overcome.

Step 33: Determine second motion information based on multiple optical flow algorithms, the second image, and a position of the target plane in the adjusted image, so that the second motion information is used to describe a position change of the target plane occurring when the target plane moves from the adjusted image to the second image.

It should be noted that the present disclosure does not limit the determination manner of the above "position of the target plane in the adjusted image", for example, if the adjusted image is obtained through adjusting the first frame image according to the above transformation matrix, the position of the target plane in the adjusted image can be obtained through adjusting the position of the target plane in the first frame image according to the transformation matrix.

It should also be noted that the present disclosure does not limit the implementation of the above step 33, for example, the implementation of step 33 may be similar to the implementation of the above step 221.

Based on the relevant contents of the above steps 31 to 33, it can be known that, in some scenarios, in order to overcome the defect caused by two frames of images, that are too far apart, presenting quite differently under some dimensions (such as shooting angle and other dimensions), the state (such as viewpoint and other states) of the first frame image in the video can be adjusted first to obtain an adjusted image, so that the adjusted image can describe the content, such as characteristics of the target plane and other content, described by the first frame image according to a state closer to the second image (such as the state of the first image); then solve the homography between the first image and the second image based on the position of the target plane in the adjusted image and the motion information of the target plane between the first image and the second image, so that the homography can more accurately describe the position mapping relationship of the target plane between the first image and the second image, thereby making the plane tracking implemented based on the homography more accurate.

In addition, in some scenarios, in order to better meet some user requirements (such as the requirement of implanting content for a certain plane and other requirements), the above data processing method can further include the following step 41.

Step 41: Update the video (such as the updating shown in FIG. 2 or FIG. 3) based on the position of the target plane in the first image and the position of the target plane in the second image, so that the content presented on the target plane described by the updated video is different from the content presented on the target plane described by the video before updating.

It should be noted that the present disclosure does not limit the implementation of the step of "updating the video", for example, it specifically can be: for any one frame of image in the video, after acquiring the position of the target plane in the image, update the content within a plane area delineated by the position in the image, such as adding new content (such as the pentagram shown in FIG. 2) into the plane area or directly replacing the original content within the plane area with other content (such as the content replacement process shown in FIG. 3) and other updating processes, so that the updated content can completely fit the plane area, which is conducive to improving the content updating effect, such as the content implantation effect and the like.

Based on the relevant contents of the above data processing method, it can be known that the plane tracking solution provided by the present disclosure has the following advantages: the present disclosure realizes a stable and sufficient tracking solution by using multiple optical flow algorithms in combination, which is conducive to improving the tracking robustness; additionally, the present disclosure simplifies the solving process of the plane position by using the homography, which reduces the complexity of solving the plane position; and further, the present disclosure realizes long-distance stable tracking by fusing neighbor information (such as the information described by the first image) and prior information (such as the information described by the first frame image), which is conducive to improving the long-term stability of plane tracking, thereby being conducive to expanding the application range of the plane tracking solution.

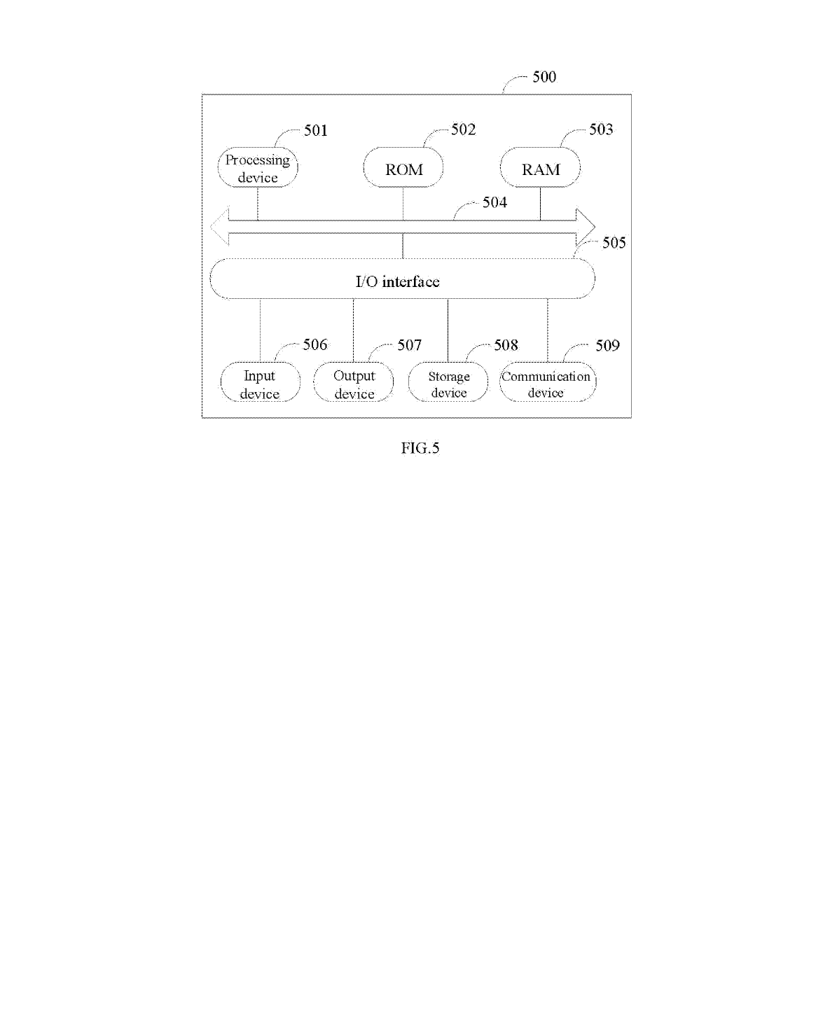

Based on the data processing method provided by the embodiments of the present disclosure, an embodiment of the present application further proposes a data processing apparatus, which will be explained and described below in conjunction with FIG. 4. FIG. 4 is a structural schematic diagram of a data processing apparatus according to an embodiment of the present application. It should be noted that technical details of the data processing apparatus provided by the embodiment of the present application can refer to the relevant contents of the above data processing method.

As shown in FIG. 4, the data processing apparatus 400 according to the embodiment of the present application may include:

an acquisition unit 401 configured to acquire a video, the video comprising a first image and a second image, an arrangement position of the first image in the video being adjacent to an arrangement position of the second image in the video, wherein the arrangement position of the first image in the video is ahead of the arrangement position of the second image in the video, wherein the first image and the second image both comprise a target plane;

a determination unit 402 configured to determine a position of the target plane in the second image based on multiple optical flow algorithms and a position of the target plane in the first image, wherein the multiple optical flow algorithms are used to determine motion information of the target plane between the first image and the second image, the motion information being used to describe a position change of the target plane occurred when the target plane moves from the first image to the second image.

In a possible implementation, the multiple optical flow algorithms include a first algorithm and a second algorithm; wherein the target plane includes multiple tracking points; the determination unit 402 is specifically configured to: for any of the tracking points, determine a position prediction result of the tracking point under the second image based on the first algorithm, the second image, and a position of the tracking point in the first image; determine a tracking result of the first algorithm for the tracking point based on the position prediction result of the tracking point under the second image, the tracking result being used to indicate whether the tracking point can be tracked from the second image by using the first algorithm; in response to the tracking result indicating that the tracking point cannot be tracked from the second image by using the first algorithm, determine the position of the tracking point in the second image based on the second algorithm, the second image, and the position of the tracking point in the first image.

In a possible implementation, the position prediction result of the tracking point under the second image is used to indicate a position obtained by forward tracking the tracking point from the first image by using the first algorithm; the determination unit 402 is specifically configured to: determine a position prediction result of the tracking point under the first image based on the first algorithm, the first image, and the position prediction result of the tracking point under the second image, the position prediction result of the tracking point under the first image being used to indicate a position obtained by backward tracking the tracking point from the second image by using the first algorithm; determine the tracking result based on a distance between the position prediction result of the tracking point under the first image and the position of the tracking point in the first image.

In a possible implementation, the determination unit 402 is specifically configured to: determine a neighboring point corresponding to the tracking point in the first image based on the position of the tracking point in the first image, and determine a neighboring point corresponding to the tracking point in the second image based on the position prediction result of the tracking point under the second image; determine the tracking result based on a difference between the neighboring point corresponding to the tracking point in the first image and the neighboring point corresponding to the tracking point in the second image.

In a possible implementation, the determination unit 402 is specifically configured to: determining first motion information based on the multiple optical flow algorithms, the second image and the position of the target plane in the first image, the first motion information being used to describe the position change of the target plane occurred when the target plane moves from the first image to the second image; solve a homography between the first image and the second image based on the first motion information, the homography being used to describe a position mapping relationship of the target plane between the first image and the second image; determine the position of the target plane in the second image based on the homography and the position of the target plane in the first image.

In a possible implementation, the determination unit 402 is specifically configured to, if the first image is not a first frame image of the video, then determine second motion information based on the multiple optical flow algorithms, the second image, and a position of the target plane in the first frame image, the second motion information being used to describe a position change of the target plane occurred when the target plane moves from the first frame image to the second image; solve the homography between the first image and the second image based on the first motion information and the second motion information.

In a possible implementation, the determination unit 402 is specifically configured to: acquire a viewpoint of the first image; adjust the first frame image based on the viewpoint of the first image to obtain an adjusted image, a viewpoint of the adjusted image being consistent with the viewpoint of the first image; determine the second motion information based on the multiple optical flow algorithms, the second image, and a position of the target plane in the adjusted image.

In a possible implementation, the viewpoint of the first image is determined based on the position of the target plane in the first image.

In a possible implementation, the data processing apparatus 400 further includes an updating unit configured to: update the video based on the position of the target plane in the first image and the position of the target plane in the second image, so that the content presented on the target plane described by the updated video is different from the content presented on the target plane described by the video before updating.

In a possible implementation, the target plane is determined based on a plane selection operation triggered for a first frame image of the video.

Based on the above related contents of the data processing apparatus 400, it can be known that the working principle of the apparatus 400 includes: for any pair of adjacent images in the video, a position of a target plane in an image arranged behind is determined based on multiple optical flow algorithms and a position of the target plane in an image arranged in front, thereby it is possible to automatically determine the position change of the target plane in the video in an iterative manner. Among them, because the multiple optical flow algorithms are used to determine motion information of the target plane between the adjacent images, the motion information can more accurately represent a position change of the target plane between the adjacent images, thereby making the position of the plane determined based on the motion information more accurate, which can effectively overcome defects caused by the fact that a single optical flow algorithm is difficult to simultaneously guarantee both tracking quantity and tracking quality, such as poor robustness and other defects, so that it is possible to implement stable and sufficient tracking of all tracking points in the target plane under the video, thereby being conducive to improving the tracking effect, for example, improving robustness of the tracking, or the like.

In addition, an embodiment of the present application further proposes an electronic device, which includes a processor and a memory; the memory is configured to store instructions or computer programs, and the processor is configured to execute the instructions or computer programs in the memory so that the electronic device performs any implementation of the data processing method provided in embodiments of the present application.

Refer to FIG. 5, which shows a structural diagram of an electronic device 500 suitable for implementing embodiments of the present disclosure. Terminal devices in embodiments of the present disclosure may include, but are not limited to, mobile terminals such as mobile phones, notebook computers, digital broadcast receivers, PDAs (Personal Digital Assistants), PADs (Portable Android Devices), PMPs (portable multimedia players), vehicle-mounted terminals (for example, vehicle-mounted navigation terminals), etc., and fixed terminals such as digital TVs, desktop computers, etc. The electronic device shown in FIG. 5 is merely an example and should not impose any limitation on the functions and usage scope of embodiments of the present disclosure.

As shown in FIG. 5, the electronic device 500 may include a processing device (such as a central processing unit, a graphics processing unit, etc.) 501, which can perform various appropriate actions and processing according to a program stored in a read-only memory (ROM) 502 or a program loaded from a storage device 508 to a random access memory (RAM) 503. Various programs and data required for operation of the electronic device 500 are also stored in the RAM 503. The processing device 501, ROM 502, and RAM 503 are connected to each other through a bus 504. An input/output (I/O) interface 505 is also connected to the bus 504.

Typically, the following devices can be connected to the I/O interface 505: an input device 506 including, for example, a touch screen, a touch pad, a keyboard, a mouse, a camera, a microphone, an accelerometer, a gyroscope, etc.; an output device 507 including, for example, a liquid crystal display (LCD), a speaker, a vibrator, etc.; a storage device 508 including, for example, a magnetic tape, a hard disk, etc.; and a communication device 509. The communication device 509 can allow the electronic device 500 to communicate with other devices wirelessly or wiredly to exchange data. Although the electronic device 500 having various devices is shown in FIG. 5, it should be understood that it is not required to implement or have all the illustrated devices. Alternatively, more or fewer devices may be implemented or included.

Particularly, according to embodiments of the present disclosure, the process described above with reference to the flowchart can be realized as a computer software program. For example, embodiments of the present disclosure include a computer program product, which includes a computer program carried on a non-transitory computer-readable medium, the computer program containing program codes for executing the method shown in the flowchart. In such embodiments, the computer program can be downloaded and installed from the network via the communication device 509, or can be installed from the storage device 508, or can be installed from the ROM 502. When the computer program is executed by the processing device 501, the above functions defined in the methods of embodiments of the present disclosure can be performed.

The electronic device provided in the embodiment of the present disclosure belongs to the same inventive concept as the method provided in the above embodiments, and technical details not described in detail in the embodiment can refer to the above embodiments, and the embodiment can achieve the same beneficial effects as that of the above embodiments.

An embodiment of the present application further proposes a computer-readable medium, which stores instructions or computer programs therein, when the instructions or computer programs run on a device, the device performs any implementation of the data processing method provided in embodiments of the present application.

It should be noted that the computer-readable medium mentioned above in the present disclosure can be a computer-readable signal medium or a computer-readable storage medium or any combination thereof. The computer-readable storage medium may be, for example, but not limited to, an electric, magnetic, optical, electromagnetic, infrared, or semiconductor system, apparatus, or device, or any combination thereof. More specific examples of the computer-readable storage medium may include, but not limited to: an electrical connection having one or more wires, a portable computer diskette, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium can be any tangible medium that contains or stores a program which can be used by or in connection with an instruction execution system, apparatus, or device. In the present disclosure, the computer-readable signal medium may include a data signal propagated in a baseband or as part of a carrier, wherein the computer-readable program code is carried. Such propagated data signals may take various forms, including but not limited to electromagnetic signals, optical signals, or any suitable combination thereof. The computer-readable signal medium may also be any computer-readable medium other than the computer-readable storage medium, and the computer-readable signal medium can send, propagate, or transmit a program for use by or in connection with an instruction execution system, apparatus, or device. Program codes contained on the computer-readable medium may be transmitted via any appropriate medium, including but not limited to: wires, optical cables, RF (radio frequency), etc., or any suitable combination thereof.

In some implementations, clients and servers may communicate using any current known or future developed network protocol such as HTTP (Hyper Text Transfer Protocol), and may interconnect with any form or medium of digital data communication (for example, a communication network). Examples of communication networks include local area networks ("LAN"), wide area networks ("WAN"), internets (for example, the Internet), and end-to-end networks (for example, ad hoc end-to-end networks), and any currently known or future developed networks.

The above computer-readable medium may be included in the above electronic device; or may exist alone and not assembled into the electronic device.

The above computer-readable medium carries one or more programs, which, when executed by the electronic device, cause the electronic device to perform the above methods.

Computer program codes for performing operations of the present disclosure may be written in one or more programming languages or combinations thereof, the programming languages including but not limited to object-oriented programming languages such as Java, Smalltalk, C++, and also including conventional procedural programming languages such as “C” language or similar programming languages. The program codes can be executed entirely on a user's computer, partially on a user's computer, as a stand-alone software package, partially on a user's computer and partially on a remote computer, or entirely on a remote computer or server. In the case involving a remote computer, the remote computer can be connected to the user's computer through any type of network, including a local area network (LAN) or wide area network (WAN), or can be connected to an external computer (for example, using an Internet service provider to connect through the Internet).

Flowcharts and block diagrams in the drawings illustrate architectures, functions, and operations that are possible implementations of systems, methods, and computer program products according to various embodiments of the present disclosure. In this regard, each block in the flowchart or block diagram can represent a module, program segment, or part of code, which includes one or more executable instructions for implementing specified logical functions. It should also be noted that, in some alternative implementations, the functions denoted by the blocks may also occur in a sequence different from that denoted in the drawings. For example, two blocks shown in succession can actually be executed substantially in parallel, they can sometimes also be executed in reverse order, depending on the involved functions. It should also be noted that each block in the block diagram and/or flowchart, and combinations of blocks in the block diagram and/or flowchart, can be implemented by a dedicated hardware-based system for performing the specified functions or actions, or can be implemented by a combination of dedicated hardware and computer instructions.

Units involved in the embodiments of the present disclosure described herein can be implemented in a software manner or a hardware manner. Among them, the names of units/modules would not limit the units per se in some cases.

The functions described hereinabove can be performed at least partially by one or more hardware logic components. For example, non-restrictively, exemplary types of hardware logic components that can be used include: Field-programmable Gate Arrays (FPGAs), Application-specific Integrated Circuits (ASICs), Application-specific Standard Products (ASSPs), System-on-Chips (SOCs), Complex Programmable Logic Devices (CPLDs), etc.

In the context of the present disclosure, machine-readable media can be tangible media, which can contain or store programs for use by or in connection with an instruction execution system, apparatus, or device. Machine-readable media can be machine-readable signal media or machine-readable storage media. Machine-readable media can include, but are not limited to, electronic, magnetic, optical, electromagnetic, infrared, or semiconductor systems, apparatuses, or devices, or any suitable combination thereof. More specific examples of machine-readable storage media would include electrical connections based on one or more wires, portable computer disks, hard disks, random access memory (RAM), read-only memory (ROM), erasable programmable read-only memory (EPROM or flash memory), fiber optics, portable compact disk read-only memory (CD-ROM), optical storage devices, magnetic storage devices, or any suitable combination thereof.

It should be noted that respective embodiments in this specification are described in a progressive way, and each embodiment focuses on the differences from other embodiments, so it is only necessary to refer to the same and similar parts between each embodiment. For the system or device disclosed in the embodiments, because it corresponds to the method disclosed in the embodiments, the description is relatively simple, and the relevant points can only be described in the method part.

It should be understood that, in the present application, "at least one (item)" refers to one or more, and "multiple" refers to two or more. "And/or" is used to describe the relationship between associated objects, indicating that three relationships can exist, for example, "A and/or B" can indicate: only A exists, only B exists, and A and B exist simultaneously, where A, B can be singular or plural. The character "/" generally indicates that the associated objects before and after it are in an "or" relationship. "At least one (item) of" or its similar expression refers to any combination of these items, including any combination of single item(s) or multiple items. For example, at least one (item) of a, b, or c, can indicate: a, b, c, "a and b", "a and c", "b and c", or "a and b and c", where a, b, c can be single, or can be multiple.

It should also be noted that, in the present disclosure, relational terms such as first and second are merely used to distinguish one entity or operation from another entity or operation, and do not necessarily require or imply any actual relationship or order between these entities or operations. Moreover, the terms "comprise", "include" or any other variants thereof are intended to cover non-exclusive inclusion, so that processes, methods, articles or devices that include a series of elements not only include those elements, but also include other elements that are not explicitly listed, or also include elements inherent to such processes, methods, articles or devices. Without further limitation, elements defined by the phrase "including a..." do not exclude the presence of additional identical elements in the processes, methods, articles or devices that include said elements.

Steps of the methods or algorithms described in conjunction with the embodiments disclosed herein can be directly implemented in hardware, in software modules executed by a processor, or in a combination thereof. Software modules can reside in RAM memory, flash memory, ROM memory, EPROM memory, EEPROM memory, registers, hard disk, removable disk, CD-ROM, or any other form of storage medium known in the art.

The above description of the disclosed embodiments enables persons skilled in the art to realize or use the present application. Various modifications to these embodiments will be readily apparent to persons skilled in the art, and the general principles defined herein may be implemented in other embodiments without departing from the spirit or scope of the present application. Thus, the present application is not intended to be limited to the embodiments shown herein but is to be accorded the widest scope consistent with the principles and novel features disclosed herein.

What is claimed is:

1. A data processing method, comprising:
acquiring a video, the video comprising a first image and a second image, an arrangement position of the first image in the video being adjacent to an arrangement position of the second image in the video, wherein the arrangement position of the first image in the video is ahead of the arrangement position of the second image in the video, wherein the first image and the second image both comprise a plane;
determining a position of the plane in the second image based on multiple optical flow algorithms and a position of the plane in the first image, wherein the multiple optical flow algorithms are used to determine motion information of the plane between the first image and the second image, the motion information being used to describe a position change of the plane when the plane moves from the first image to the second image.

2. The method of claim 1, wherein, the multiple optical flow algorithms comprise a first algorithm and a second algorithm;
wherein the plane comprises multiple tracking points;
wherein, for any of the tracking points, the determining a position of the tracking point in the second image comprises:
determining a position prediction result of the tracking point under the second image based on the first algorithm, the second image, and a position of the tracking point in the first image;
determining a tracking result of the first algorithm for the tracking point based on the position prediction result of the tracking point under the second image, the tracking result being used to indicate whether the tracking point is tracked from the second image by using the first algorithm;
in response to the tracking result indicating that the tracking point is not tracked from the second image by using the first algorithm, determining the position of the tracking point in the second image based on the second algorithm, the second image, and the position of the tracking point in the first image.

3. The method of claim 2, wherein the position prediction result of the tracking point under the second image is used to indicate a position obtained by forward tracking the tracking point from the first image by using the first algorithm;
wherein, the determining the tracking result comprises:
determining a position prediction result of the tracking point under the first image based on the first algorithm, the first image, and the position prediction result of the tracking point under the second image, the position prediction result of the tracking point under the first image being used to indicate a position obtained by backward tracking the tracking point from the second image by using the first algorithm;
determining the tracking result based on a distance between the position prediction result of the tracking point under the first image and the position of the tracking point in the first image.

4. The method of claim 2, wherein, the determining the tracking result comprises:
determining a neighboring point corresponding to the tracking point in the first image based on the position of the tracking point in the first image, and determining a neighboring point corresponding to the tracking point in the second image based on the position prediction result of the tracking point under the second image;
determining the tracking result based on a difference between the neighboring point corresponding to the tracking point in the first image and the neighboring point corresponding to the tracking point in the second image.

5. The method of claim 1, wherein, the determining the position of the plane in the second image comprises:
determining first motion information based on the multiple optical flow algorithms, the second image and the position of the plane in the first image, the first motion information being used to describe the position change of the plane when the plane moves from the first image to the second image;
solving a homography between the first image and the second image based on the first motion information, the homography being used to describe a position mapping relationship of the plane between the first image and the second image;
determining the position of the plane in the second image based on the homography and the position of the plane in the first image.

6. The method of claim 5, wherein in response to the first image being not a first frame image of the video, then the determining the homography comprises:
determining second motion information based on the multiple optical flow algorithms, the second image, and a position of the plane in the first frame image, the second motion information being used to describe a position change of the plane when the plane moves from the first frame image to the second image;
solving the homography between the first image and the second image based on the first motion information and the second motion information.

7. The method of claim 6, wherein the determining the second motion information comprises:
acquiring a viewpoint of the first image;
adjusting the first frame image based on the viewpoint of the first image to obtain an adjusted image, a viewpoint of the adjusted image being consistent with the viewpoint of the first image;
determining the second motion information based on the multiple optical flow algorithms, the second image, and a position of the plane in the adjusted image.

8. The method of claim 7, wherein the viewpoint of the first image is determined based on the position of the plane in the first image.

9. The method of claim 1, further comprising:
updating the video based on the position of the plane in the first image and the position of the plane in the second image, so that the content presented on the plane described by the updated video is different from the content presented on the plane described by the video before updating.

10. The method according to claim 1, wherein the plane is determined based on a plane selection operation triggered for a first frame image of the video.

11. An electronic device, comprising: a processor and a memory;
wherein the memory is configured to store instructions or computer programs;
wherein the processor is configured to execute the instructions or computer programs stored in the memory, so as to cause the electronic device to perform:
acquiring a video, the video comprising a first image and a second image, an arrangement position of the first image in the video being adjacent to an arrangement position of the second image in the video, wherein the arrangement position of the first image in the video is ahead of the arrangement position of the second image in the video, wherein the first image and the second image both comprise a plane;
determining a position of the plane in the second image based on multiple optical flow algorithms and a position of the plane in the first image, wherein the multiple optical flow algorithms are used to determine motion information of the plane between the first image and the second image, the motion information being used to describe a position change of the plane when the plane moves from the first image to the second image.

12. The electronic device of claim 11, wherein the multiple optical flow algorithms comprise a first algorithm and a second algorithm;
wherein the plane comprises multiple tracking points;
wherein, for any of the tracking points, the determining a position of the tracking point in the second image comprises:
determining a position prediction result of the tracking point under the second image based on the first algorithm, the second image, and a position of the tracking point in the first image;
determining a tracking result of the first algorithm for the tracking point based on the position prediction result of the tracking point under the second image, the tracking result being used to indicate whether the tracking point is tracked from the second image by using the first algorithm;
in response to the tracking result indicating that the tracking point is not tracked from the second image by using the first algorithm, determining the position of the tracking point in the second image based on the second algorithm, the second image, and the position of the tracking point in the first image.

13. The electronic device of claim 12, wherein the position prediction result of the tracking point under the second image is used to indicate a position obtained by forward tracking the tracking point from the first image by using the first algorithm;
wherein, the determining the tracking result comprises:
determining a position prediction result of the tracking point under the first image based on the first algorithm, the first image, and the position prediction result of the tracking point under the second image, the position prediction result of the tracking point under the first image being used to indicate a position obtained by backward tracking the tracking point from the second image by using the first algorithm;
determining the tracking result based on a distance between the position prediction result of the tracking point under the first image and the position of the tracking point in the first image, or
wherein, the determining the tracking result comprises:
determining a neighboring point corresponding to the tracking point in the first image based on the position of the tracking point in the first image, and determining a neighboring point corresponding to the tracking point in the second image based on the position prediction result of the tracking point under the second image;
determining the tracking result based on a difference between the neighboring point corresponding to the tracking point in the first image and the neighboring point corresponding to the tracking point in the second image.

14. The electronic device of claim 11, wherein the determining the position of the plane in the second image comprises:
determining first motion information based on the multiple optical flow algorithms, the second image and the position of the plane in the first image, the first motion information being used to describe the position change of the plane when the plane moves from the first image to the second image;
solving a homography between the first image and the second image based on the first motion information, the homography being used to describe a position mapping relationship of the plane between the first image and the second image;
determining the position of the plane in the second image based on the homography and the position of the plane in the first image.

15. The electronic device of claim 11, wherein the processor is configured to execute the instructions or computer programs stored in the memory, so as to cause the electronic device to further perform:
updating the video based on the position of the plane in the first image and the position of the plane in the second image, so that the content presented on the plane described by the updated video is different from the content presented on the plane described by the video before updating.

16. A non-transitory computer-readable storage medium, wherein the computer-readable storage medium stores instructions or computer programs, which, when executed on a device, cause the device to perform:
acquiring a video, the video comprising a first image and a second image, an arrangement position of the first image in the video being adjacent to an arrangement position of the second image in the video, wherein the arrangement position of the first image in the video is ahead of the arrangement position of the second image in the video, wherein the first image and the second image both comprise a plane;
determining a position of the plane in the second image based on multiple optical flow algorithms and a position of the plane in the first image, wherein the multiple optical flow algorithms are used to determine motion information of the plane between the first image and the second image, the motion information being used to describe a position change of the plane when the plane moves from the first image to the second image.

17. The non-transitory computer-readable storage medium of claim 16, wherein the multiple optical flow algorithms comprise a first algorithm and a second algorithm;
wherein the plane comprises multiple tracking points;
wherein, for any of the tracking points, the determining a position of the tracking point in the second image comprises:
determining a position prediction result of the tracking point under the second image based on the first algorithm, the second image, and a position of the tracking point in the first image;
determining a tracking result of the first algorithm for the tracking point based on the position prediction result of the tracking point under the second image, the tracking result being used to indicate whether the tracking point is tracked from the second image by using the first algorithm;
in response to the tracking result indicating that the tracking point is not tracked from the second image by using the first algorithm, determining the position of the tracking point in the second image based on the second algorithm, the second image, and the position of the tracking point in the first image.

18. The non-transitory computer-readable storage medium of claim 17, wherein the position prediction result of the tracking point under the second image is used to indicate a position obtained by forward tracking the tracking point from the first image by using the first algorithm;
wherein, the determining the tracking result comprises:
determining a position prediction result of the tracking point under the first image based on the first algorithm, the first image, and the position prediction result of the tracking point under the second image, the position prediction result of the tracking point under the first image being used to indicate a position obtained by backward tracking the tracking point from the second image by using the first algorithm;
determining the tracking result based on a distance between the position prediction result of the tracking point under the first image and the position of the tracking point in the first image, or
wherein, the determining the tracking result comprises:
determining a neighboring point corresponding to the tracking point in the first image based on the position of the tracking point in the first image, and determining a neighboring point corresponding to the tracking point in the second image based on the position prediction result of the tracking point under the second image;
determining the tracking result based on a difference between the neighboring point corresponding to the tracking point in the first image and the neighboring point corresponding to the tracking point in the second image.

19. The non-transitory computer-readable storage medium of claim 16, wherein the determining the position of the plane in the second image comprises:
determining first motion information based on the multiple optical flow algorithms, the second image and the position of the plane in the first image, the first motion information being used to describe the position change of the plane when the plane moves from the first image to the second image;
solving a homography between the first image and the second image based on the first motion information, the homography being used to describe a position mapping relationship of the plane between the first image and the second image;
determining the position of the plane in the second image based on the homography and the position of the plane in the first image.

20. The non-transitory computer-readable storage medium of claim 16, wherein the computer-readable storage medium stores instructions or computer programs, which, when executed on a device, cause the device to further perform:
updating the video based on the position of the plane in the first image and the position of the plane in the second image, so that the content presented on the plane described by the updated video is different from the content presented on the plane described by the video before updating.
